(19) United States
(12) Patent Application Publication
(10) Pub. No.: US 2022/0284828 A1
(43) Pub. Date: Sep. 8, 2022

(54) TOILET TISSUE PRODUCT WITH PRINTED TRAINING SYMBOL OR MARKER AND METHOD OF MANUFACTURING THE SAME

(71) Applicant: Jaime MCCLELLAND, Eugene, OR (US)

(72) Inventor: Jaime MCCLELLAND, Eugene, OR (US)

(21) Appl. No.: 17/228,265

(22) Filed: Apr. 12, 2021

Related U.S. Application Data
(60) Provisional application No. 63/155,652, filed on Mar. 2, 2021.

(51) Int. Cl. G09B 19/00; A47K 10/22; D21H 27/00; D21H 19/66

(52) U.S. Cl. CPC G09B 19/0076; A47K 10/22; D21H 27/002; D21H 19/66

(57) ABSTRACT

The present application provides a toilet tissue product and method of manufacturing the same. The toilet tissue product includes a roll of toilet paper including a symbol that provides a user with a visual guide to dispense a sufficient number of perforated sheets. The symbol can be printed with ink or dye, or can be formed by way of an embossing or stamping technique. The toilet paper roll can be used as a training aide for children learning proper bathroom habits.

### RELATED APPLICATION

The present application claims priority to U.S. Provisional Patent Application No. 63/155,652 filed on Mar. 2, 2021, which is incorporated herein by reference.

### BACKGROUND

Humans have used a variety of natural tools and materials to clean themselves after using the toilet. In ancient times, wiping with stones, seashells, furs, sponges, and other natural materials and rinsing with water or snow was common after a bowel movement. In the early 14^{th} century, toilet paper was being manufactured and used in China. Commercially available toilet paper did not begin in the western hemisphere until 1857. The first perforated toilet paper rolls were introduced in the 1890s.

Children using too much toilet paper is a common problem during their toilet training years. Parents and guardians can find toilet training or “potty training” a frustrating task to teach children. The clogging of the toilet with too much toilet paper can lead to messy overflows onto the bathroom floor resulting in unsanitary conditions. It is not uncommon for children to playfully dispose of the entire roll of toilet paper into the water of the toilet bowl. Children are also known to spin the entire toilet paper roll onto the floor.

Prior attempts have been made to provide visual strategies to help children learn and maintain proper bathroom habits and help eliminate toilet paper waste. Parents and guardians of special needs children, such as children with autism spectrum disorder, can find toilet training especially difficult. Visual strategies during toilet training have helped alleviate some of those challenges associated with children having autism. Visual cues are known to help stop the impulsive behavior of children with autism. Lines or markings placed on a wall at a distance or off to the side of a toilet when a child is using/sitting on the toilet have been previously used. For example, stickers, directional arrows, or lines can be placed on the wall below a mounted toilet roll dispenser, such that the child dispenses a length of sheets that reaches the sticker, directional arrow or line positioned on one or both sides of the sheet of toilet paper.

### SUMMARY

There is further need for an approach to provide improved visual strategies to assist children, including children with special needs, with learning and maintaining proper bathroom habits with respect to toilet paper usage.

According to one embodiment, there is provided a toilet paper roll including a plurality of perforated sheets. A marking or symbol is formed on individual sheets of the toilet paper, providing a user with a visual guide for dispensing a select number of toilet paper sheets. A predetermined spacing between each marking or symbol is maintained throughout the entire roll of toilet paper.

According to another embodiment, there is provided a method of manufacturing a toilet paper roll. The method includes generating a roll of toilet paper, forming markings or symbols at a predetermined portions along the length of the roll of toilet paper. A predetermined spacing between each printed marking or symbol is maintained throughout roll of toilet paper.

In certain embodiments, the symbol or marking can be formed on the toilet paper with ink or dyes. In other embodiments, the symbol or marking can be formed on the toilet paper, preferably multi-ply toilet paper, by way of a stamping or embossing technique such that the printed symbol or marking comprises a raised surface, with a least a portion of the symbol or marking being higher than the surrounding toilet paper area.

In yet another embodiment, a packaging of a plurality of toilet paper rolls is provided. Each toilet paper roll includes a plurality of perforated sheets. A symbol or marking is formed on some of the perforated sheets of each toilet paper roll, and spaced apart at a predetermined distance. The marking or symbol provides a user with a visual guide for dispensing a sufficient amount of toilet paper sheets. A predetermined spacing between each symbol or marking is maintained throughout roll of toilet paper. The symbol or marking can be the same or different for each of the toilet paper rolls included in the packaging. In certain embodiments, the symbol or marking can be printed with ink or dye, or can be formed by way of an embossing or stamping technique.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is an illustration of a toilet paper roll including a printed symbol or marker, according to one embodiment;

FIG. 2 is an illustration of a toilet paper roll including an embossed or stamped symbol or marker, according to another embodiment;

FIGS. 3A through 3K are illustrative examples of symbols or markers for use on the toilet paper rolls, according to one embodiment;

FIG. 4 is an illustrative example of packaging for toilet paper rolls with different symbols or markers, according to one embodiment;

FIG. 5 is an illustrative example of packaging for toilet paper rolls with the same symbol or marker, according to another embodiment; and

FIG. 6 is an illustrative example of an industrial roll of toilet paper including the symbols and markers prior to transfer of the industrial onto tubular cardboard and cut into individual toilet paper rolls, according to one embodiment.

### DESCRIPTION

Examples of providing toilet paper rolls formed with a symbol or marking for toilet training purposes are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

The present invention provides a toilet paper roll including a symbol or marking printed on some of the individual perforated sheets of the toilet paper roll. The marking or symbol provides a user, such as a child, with a visual guide for dispensing a select number of toilet paper sheets from the roll. A predetermined spacing between each printed marking or symbol is maintained throughout roll of toilet paper. The marking or symbol serves as a visual aide or cue to help train or guide the user not to use too much toilet paper after urination or a bowel movement.

In certain embodiments, the symbol or marking is formed on the individual sheets of toilet paper by way of a printing technique using inks or dyes. The symbol or marking can be printed in any color(s). In other embodiments, an embossed or stamped symbol or marking is formed on the individual sheets of toilet paper. The embossed or stamped symbol can be colored or can be the same color as the rest of the roll of toilet paper. The raised surfaces of the embossed/stamped symbol or marking provide the user with a visual guide as well as a touch/textural guide. The embossed or stamped symbol or marker is especially helpful for visually impaired users.

Providing a visual guide or cue directly on a sheet of toilet paper at a predetermined spacing, reminds the user to be mindful of using a proper amount of toilet paper thereby avoiding waste and preventing messy accidents caused by a clogged toilet. In certain situations, the toilet roll is not on a holder, or the user prefers to hold the roll in their hand while sitting on the toilet. A visual guide printed on the roll and in the user's line of sight is more useful than a line or marking that is placed on the wall, often times off to the side of the toilet and not in the user's line of sight.

Toilet paper with printed designs and images are previously known. Printed cartoon characters, holiday themes, flowers, custom photos, etc., can be printed on the perforated sheets of the toilet paper roll. However, the designs and images are printed on each sheet of the toilet paper roll. Further, the designs and images printed on conventional toilet paper do not provide any visual aide to assist a user, such as a child, from using too much toilet paper.

In accordance with certain embodiments, visual symbols or markings printed on some of the sheets of the toilet paper provide a useful tool that help solve many challenges associated with toilet training, especially with children having autism. A stop sign is a universally understood symbol that children see in everyday life. It is a cue for a person to stop what they were doing. The stop sign symbol can help a child with special needs, such as autism, manage impulsive behavior as is relates to toilet paper usage. The child can quickly recognize the stop sign while using the toilet and be reminded to use only the amount of toilet paper needed. In certain examples, the stop sign will appear on every sixth sheet. The child of course can use more than the six sheets if needed, but will be reminded at every sixth sheet to be not use an excessive amount of toilet paper.

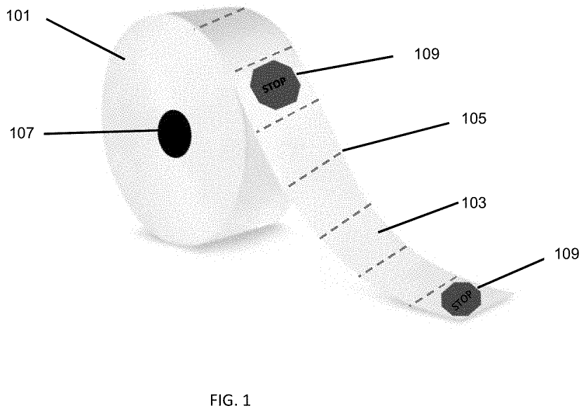

FIG. 1 provides an illustration of a toilet paper roll 101 in accordance with one embodiment of the present invention. The toilet paper roll 101 comprises a plurality of perforated sheets 103 rolled around a tube 105 formed of cardboard or other commercially available material. It is noted that toilet paper is also commonly referred to as toilet tissue, bog roll, bathroom tissue, loo paper, loo roll, bog paper, lavvy paper, or sanitized paper. There are a variety of types of toilet paper including soft, quilted, strong quilted, luxury, biodegradable, high capacity rolls, etc. The toilet paper can be white or another color, including an unbleached brown. Toilet paper can be made out of bamboo. Each of these toilet paper types can be used with the present invention.

The toilet paper roll 101 of FIG. 1 is shown separate from a toilet paper dispenser which can be a wall-mounted or free standing unit adjacent a toilet to hold the one or more toilet paper rolls 101. In FIG. 1, the symbol or marking 109 is disposed on individual sheets 103 at a predetermined distances. In this non-limiting example, the symbol or marking 109 is provided on every sixth sheet. The distance between each symbol or marking 109 can vary. It is estimated that a person uses about 8.6 sheets per trip to the bathroom. Thus, in other examples, the distance between each symbol or marking 109 can be 7, 8 or 9 sheets. In this example, the symbol or marking is primarily colored red to distinguish itself from the rest of the paper and provide a clear visual aide. Different color(s) can be used. For instance, the octagonal shape of the symbol or marker 109 can be red and the lettering of S-T-O-P can be black or white. In other embodiments, assuming the toilet paper is white, the area comprising the lettering can be left blank such that the lettering appears white without the need of using additional ink/dye beyond the red for the rest of the octagon.

The symbol or marking 109 is printed on some of the sheets 103 during manufacturing of the toilet paper roll 101. Safe to use inks or dyes can be used to print the symbol or marking 109. In other embodiments, a stamper or embosser can be used during the manufacturing process of the toilet paper to create a raised symbol or marking 109 with optional coloring added. The raised surface of the embossed symbol or marking 109 distinguishes it from other sheets in terms of its visual appearance and feel. The embossing or stamping technique is better suited with multi-ply sheets (e.g., two-ply, or three-ply).

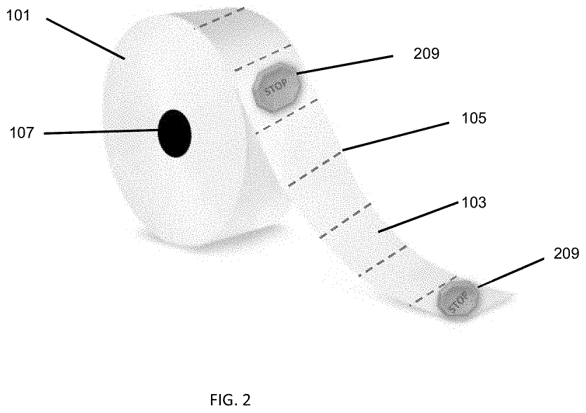

FIG. 2 illustrates an example of an embossed symbol or marking 209 wherein the stop sign (octagonal shape) and lettering (S-T-O-P) are raised above the surface of the rest of the sheet 103. In some examples, the symbol or marking 209 in FIG. 2 the same color as the paper of the toilet paper roll 101 without using any ink or dye. In other embodiments, the marking or symbol 209 can be singe or multi-colored. Further, in certain examples, the lettering S-T-O-P of symbol or marking 209 can have the same or different color than the rest of the octagonal shape.

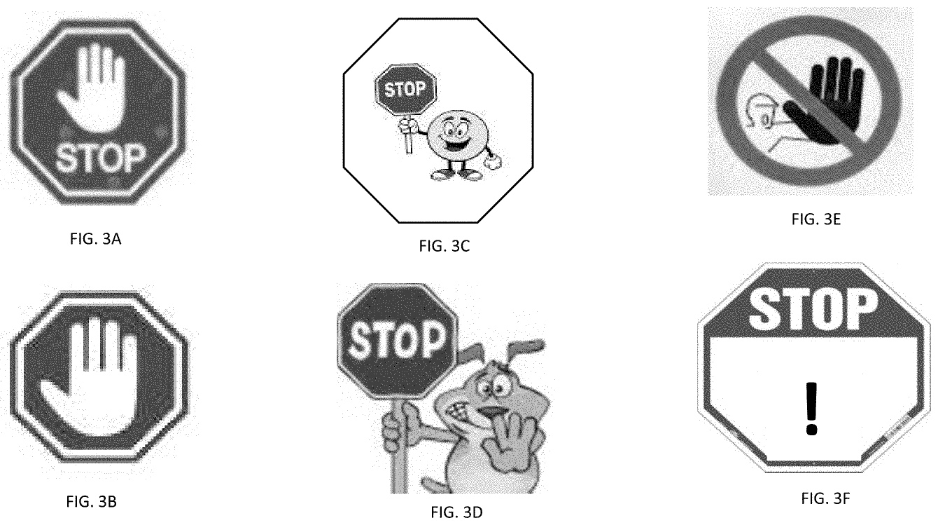

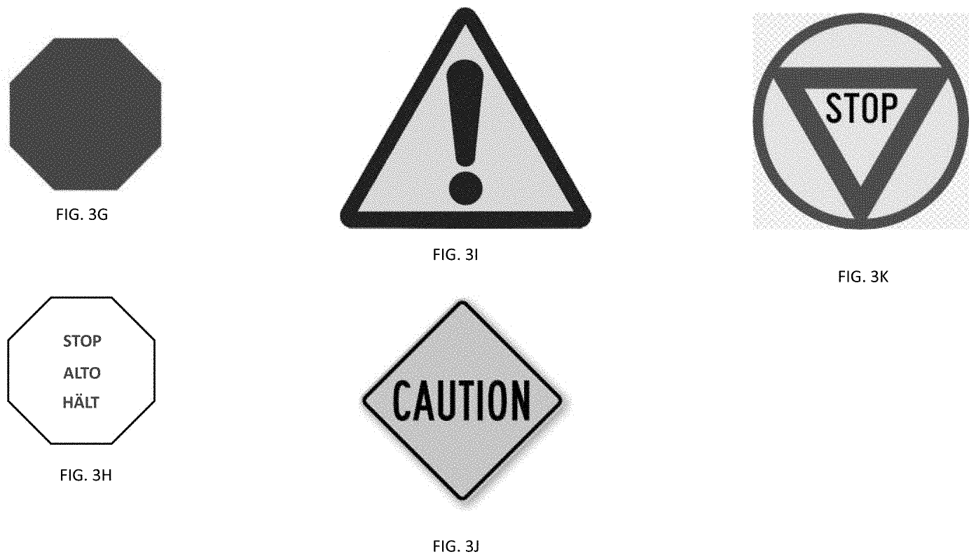

Other examples of the type of symbols or markings that can be used with the present invention are illustrated in FIGS. 3A-3K. These non-limiting examples of visual symbols, guides, or markings are to be printed or formed on the toilet paper roll.

In FIG. 3A, a combination of a symbol (e.g., hand) and lettering (S-T-O-P) can be used. The lettering, hand symbol and outline in this example can be printed with white ink or die, or left colorless such that the white toilet paper appears through the openings. The remaining portions can be printed in a solid color such as red. FIG. 3B is substantially similar to that of FIG. 3A, but in this example, only a hand symbol is used. A child can easily recognize the hand symbol as a gesture to stop using too much toilet paper.

In FIG. 3C, an emoji like character holding a stop sign within an octagonal frame is illustrated. In FIG. 3D, a cartoon animal character holding a stop sign is illustrated. Again, other languages besides English, or in combination with English can be used.

In FIG. 3E, a person with an outstretched hand within a crossed-out circle is illustrated. This image provides an alternative example that would remind the user to be mindful of using too much toilet paper while using the toilet. FIG. 3F is a variation of a traditional stop sign, maintaining its traditional octagon shape, but including the S-T-O-P lettering together with a punctuation symbol (e.g., exclamation point).

In FIG. 3G, a solid colored octagon that identifies a stop sign can be used without lettering. In FIG. 3H, an octagon outline encloses the English, Spanish and German words for STOP. The number of languages printed is not limiting. The language(s) can vary depending on where the toilet paper roll is manufactured and sold.

In FIG. 3I, a triangular-shaped caution sign is illustrated. Caution signs are traditionally yellow in color, but can be printed in one or more other colors in accordance with certain embodiments. FIG. 3J is a further example of a four-sided caution sign with the lettering C-A-U-T-I-O-N provided. FIG. 3K is a further variation of a stop sign with the lettering S-T-O-P and enclosed within both a triangle and circle. One or more colors can be used in the example of FIG. 3K.

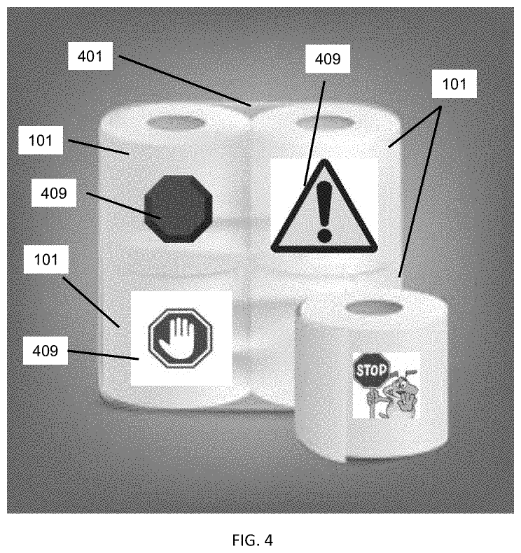

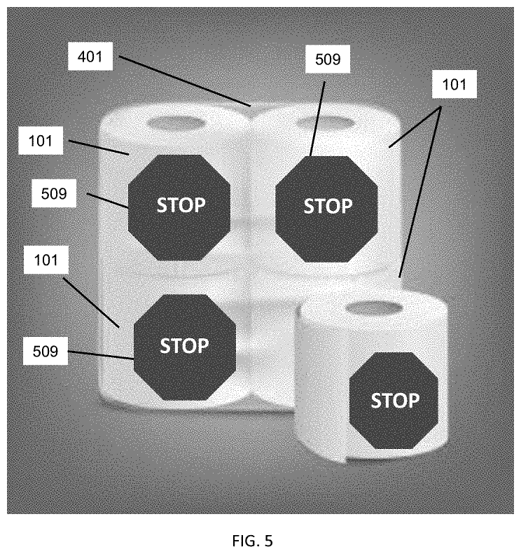

In other embodiments, packaging of multiple rolls each with a different symbol or marking produced. The example in FIG. 4, includes packaging 401 containing multiple toilet paper rolls 101 having a variety of symbols or markings 409. The variety pack is useful for determining an individual user's preferred choice of symbol or marking 409. Some users will prefer one symbol or marking 409 over another and better bathroom habits can be established. In settings such as schools or daycare centers, some children may react more favorably to one symbol or marking 409 over another, which will assist in improving that child's toilet routine/behavior. Daycare centers with multiple children could have different types of rolls ready for each child to pick out before using bathroom to assist with training and improving the child's bathroom habits.

FIG. 5 is similar to the example in FIG. 4, but the symbol or marking 509 on each toilet paper roll 101 is the same for the entire package 401. The packaging 401 for the examples in FIGS. 4 and 5 can include plastic wrapping around the plurality of toilet paper rolls 101. Alternatively, the toilet paper rolls can be individually wrapped in an outer paper wrapper (not shown), or the toilet paper rolls 101 can be placed in a cardboard box (not shown) as individual rolls or wrapped in an additional plastic packaging prior to placement in the cardboard box. The examples provided for the packaging material are not limited to those described herein. Other commercially available packaging can be used.

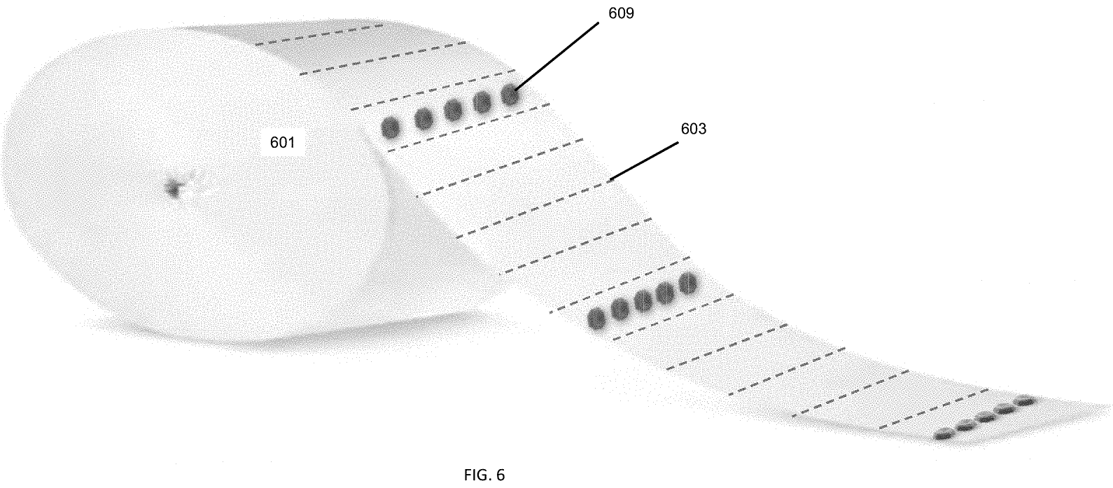

FIG. 6 is an illustration of an industrial roll of toilet paper 601. The industrial roll of toilet paper 601 in this example provides the perforations 603 and symbols or markers 609 formed across the width of the industrial roll 601. The symbols or markers 609 can be printed or embossed with one of the techniques described herein. In this example, the industrial roll includes embossed and colored symbols or markers 609. The industrial roll 601 will be further processed onto cardboard rolls, cut into individual rolls, and packaged for shipping. In this example, each toilet paper roll produced will contain a symbol or marker 609 every sixth perforated sheet. It should be understood that the step of applying the symbol or marker 609 can vary during the manufacturing process of each toilet paper roll.

The embodiments of the present disclosure can achieve several technical effects, such as providing toilet paper rolls with symbols or markers as visual guides or cues for users to limit toilet paper usage, thereby decreasing waste and reducing the risk of clogging of the toilet. The toilet paper roles are especially beneficial for children learning to toilet train. Toilet paper rolls formed in accordance with embodiments of the present disclosure are useful in various settings including homes, schools, and daycare centers.

In the preceding description, the present disclosure is described with reference to specifically exemplary embodiments thereof. It will, however, be evident that various modifications and changes may be made thereto without departing from the broader spirit and scope of the present disclosure, as set forth in the claims. The specification and drawings are, accordingly, to be regarded as illustrative and not as restrictive. It is understood that the present disclosure is capable of using various other combinations and embodiments and is capable of any changes or modifications within the scope of the inventive concept as expressed herein.

What is claimed:

1. A toilet paper roll comprising:
a plurality of perforated sheets disposed on a tube;
a symbol formed on a predetermined number of the plurality of perforated sheets,
wherein each symbol is separated by an equal number of perforated sheets to provide a user with a visual guide to dispense a sufficient number of perforated sheets.

2. The toilet paper roll according to claim 1, wherein each symbol is separated by the equal number of perforated sheets throughout the entire roll of toilet paper.

3. The toilet paper roll according to claim 1, wherein each symbol is printed on an individual perforated sheet and comprises one or more colors.

4. The toilet paper roll according to claim 3, wherein each symbol is selected from the group consisting of: stop sign, caution sign, and a hand sign.

5. The toilet paper roll according to claim 4, wherein the stop sign comprises an octagonal frame.

6. The toilet paper roll according to claim 5, wherein the word STOP is provided within the octagonal frame.

7. The toilet paper roll according to claim 4, wherein the caution sign comprises a triangular frame and the word CAUTION provided within the triangular frame.

8. The toilet paper roll according to claim 1, wherein each symbol is embossed on an individual perforated sheet and optionally comprises one or more colors.

9. The toilet paper roll according to claim 1, wherein each embossed symbol is selected from the group consisting of: stop sign, caution sign, and a hand sign.

10. A method of manufacturing a toilet paper roll, the method comprising the steps of:
forming a symbol on a predetermined number of a plurality of perforated sheets; and
generating a roll of toilet paper comprising the plurality of perforated sheets disposed on a tube,
wherein each symbol is separated by an equal number of perforated sheets to provide a user with a visual guide to dispense a sufficient number of perforated sheets.

11. The method of claim 10, wherein the forming step comprises printing or embossing the symbol on the predetermined number of the plurality of perforated sheets.

12. The method of claim 11, wherein the printing comprises printing the symbol in one or more colors.

13. The method of claim 11, wherein each embossed symbol comprises one or more colors, and each embossed symbol is embossed on a multi-ply perforated sheet.

14. The method of claim 10, wherein each symbol is selected from the group consisting of: stop sign, caution sign, and a hand sign.

15. The method according to claim 14, wherein the stop sign comprises an octagonal frame.

16. The method according to claim 15, wherein the word STOP is provided within the octagonal frame.

17. A packaging comprising:
one or more toilet paper rolls enclosed in wrapping;
each toilet paper roll comprising a plurality of perforated sheets disposed on a tube;
a symbol formed on a predetermined number of the plurality of perforated sheets of each toilet paper roll,
wherein each symbol is separated by an equal number of perforated sheets to provide a user with a visual guide to dispense a sufficient number of perforated sheets.

18. The packaging of claim 17, wherein a plurality of toilet paper rolls is provided in the wrapping and each toilet paper roll comprises the same symbol printed or embossed on the predetermined number of the plurality of perforated sheets.

19. The packaging of claim 18, wherein each symbol is selected from the group consisting of: stop sign, caution sign, and a hand sign.

20. The packaging of claim 17, wherein a plurality of toilet paper rolls is provided in the wrapping and at least one toilet paper roll comprises a first symbol, and at least a second toilet paper roll comprises a second symbol different from the first symbol.
